(19) United States
(12) Patent Application Publication
(10) Pub. No.: US 2021/0144933 A1
(43) Pub. Date: May 20, 2021

(54) Expandable Greenhouse for Growing Trees and Large Plants

(71) Applicant: Sergey Gazenko, Summerville, SC (US)

(72) Inventor: Sergey Gazenko, Summerville, SC (US)

(21) Appl. No.: 16/689,392

(22) Filed: Nov. 20, 2019

(51) Int. Cl. A01G 13/04; A01G 9/14

(52) U.S. Cl. CPC A01G 13/04; A01G 9/14

(57) ABSTRACT

This invention describes expandable greenhouse for growing plants, mainly trees and shrubs from sprouts to maturity in order to protect them from harsh weather conditions of unusual for them growing zones. Greenhouse expands by re-arranging of constructive elements mainly without addition or removing of those elements.

### FIELD OF THE INVENTION

The present invention relates to greenhouses for growing plants, mainly trees and shrubs from sprouts to maturity in order to protect them from harsh weather conditions without having to replant.

### BACKGROUND OF THE INVENTION

Greenhouses are known from ancient times. They protect plants from unwanted weather conditions like low or high temperatures, solar radiation, winds, humidity, etc.

Some of them are used for agricultural purposes while other, like winter gardens (orangeries) are used for recreation of scientific-botanical purposes.

Design of greenhouses vary depending on their purpose. Thus, commercial greenhouses used for vegetable, greenery or flowers are long semicircular constructions based on metal or wooden frame and covered by plastics such as vinyl or polyethylene film, polycarbonate sheets or glass (acrylic or regular).

Winter gardens are relatively big architectural constructions with roof and walls covered by glass. They are suitable for small as well as big plants like trees, palms, cacti, agaves, etc. They are expensive and used not for just one but for large number of plants including trees.

Different types of greenhouses are used currently by homeowners in their backyards for different purposes. Only some of them designed are for protection of single tree from harsh condition, especially cold winter. Thus, plant cover bags from companies such as Phi Villa and Agfabric are used for temporary protection from mild cold but not from severe cold. They cover the crown only and not the trunk. Also, they have no space for heating devices. Cover bags must be changed each year due to increasing size of the growing tree.

Several companies manufacture and sell portable greenhouses with plastic cover: Quictent, Home-Complete, KapscoMoto, FDW, etc. It is not possible to use these greenhouses for growing trees from sprouts to maturity due to their fixed size.

Zip Domes LLC offers geodesic domes that can be used as greenhouses. This structure does not expand and, therefore, used only for mature trees.

U.S. Pat. No. 8,307,580 describes spectrally selective growth tube that can be used to shelter small (1-2 years old) trees. Trees of 3 years and older must be replanted in an expansive winter garden or big greenhouse must be built around. Thus, growth tube can't be used for relatively big—mature trees.

U.S. Pat. No. 4,672,888 describes closure for inflatable greenhouse. This greenhouse has certain size when inflated, which means it can be used only for trees of certain size.

U.S. Pat. No. 4,831,793 describes a novel greenhouse or storage structure of simplistic design permitting controlled insulation and solar exposure. This design doesn't allow change of size of greenhouse.

U.S. Pat. Nos. 10,251,346 and 9,642,315 describes top furling automated retractable greenhouse cover which is a retractable cover for a greenhouse that is mounted on top of the greenhouse. This design is suitable for growing small plants but not trees of different ages.

U.S. Pat. No. 8,151,518 describes a vertically-integrated greenhouse for growing plants in suspended trays. This design is useful for small plants for indoor or outdoor use but not for big and small trees.

U.S. Pat. No. 4,154,253 describes greenhouse structure from rings. This structure doesn't allow change of shape and size.

Analysis of prior art shows that none of the currently existing greenhouses or similar devices can support growth of relatively big plants (trees, shrubs, palms) from sprouts to mature age without changing the size of the greenhouse multiple times as the plant grows to a big size. This change is a laborious and expensive process due to the multiple changes required.

Current invention allows to the use of a single greenhouse from sprout to mature tree because its size increases in accordance with the size of the tree/growing plant.

### SUMMARY OF THE INVENTION

Current invention describes a greenhouse which can expand in size and increase in volume several times by changing geometrical features of constructive elements.

Current invention allows growing of trees and other large plants (big shrubs, palms) that are initially small in size in a small greenhouse and progressing to larger greenhouse that can fit mature tree. Conversion of greenhouse from small to big size is simple and takes few minutes. The total number of constructive elements of this highly expandable greenhouse remain the same in every stage from smallest to largest. No additional parts or removing of extra parts is needed. This is achieved by geometrical rearrangement of structural elements of construction.

Initially small size of greenhouse covers small—several square feet area and is a few feet in height. After 1-3 years inner structural elements (bearing bars) are re-arranged, structural (thick) tubes of the construction are moved apart to make enclosed area significantly larger and thin tubes inserted inside the thick tubes are pulled out to make construction taller. Thus, size and volume of construction expands significantly, adjusting to the size of plant. Plastic covered greenhouse (clear polyethylene, clear vinyl or other suitable material) folded in the beginning unfolds according to the size of the greenhouse and always protects enclosed space from cold, wind or other harsh weather conditions. Thus, greenhouse virtually “grows” together with the tree/plant.

Such a design doesn't need additional materials or replacing one expensive greenhouse with another.

Re-arrangement of bearing bars and fixing of small tube with screws, bolts or other fixing method of structural elements are simple operations.

Main structural elements are PVC (Polyvinyl chloride), CPVC (Chlorinated Polyvinyl chloride) or other suitable polymer tubes. These tubes are strong, rigid yet flexible. Flexibility of tubes allows form/change of shape of construction, making space for the tree crown larger or smaller. The use of metal curved tubes is also possible.

Polymer tubes, greenhouse vinyl or polyethylene, screws, bolts and other fixing elements are inexpensive materials. Assembling and reassembling is simple and fast. Thus, the entire construction is inexpensive.

Relatively large bottom/soil area allows the installation of heating or cooling devices, humidifier, watering system or day light lamps attached on the inside if needed.

Invented greenhouse allows plants belonging to one climatic zone to grow in another climatic zone outside houses or in winter gardens by simple and cost-effective manner. It also allows growing of large plants from sprouts to mature plant without replanting or replacing the existing greenhouse. Expandable greenhouses may open big new perspectives for individual and even industrial agriculture.

### BRIEF DESCRIPTION OF THE DRAWINGS

FIG. 1 shows general view of expandable greenhouse in medium size stage.

FIG. 2 shows greenhouse in initial—minimal size stage.

FIG. 3 shows greenhouse connections of bearing bars and thick tubes at minimal size stage (projection from above).

FIG. 4 shows greenhouse at maximal large stage.

FIG. 5 shows greenhouse inner connections of bearing bars and thick tubes at maximal large stage (projection from above).

FIGS. 6 and 7 shows fixation of bearing bars to thick tubes and ratio of squares of the bottom at minimal (FIG. 6) and maximal (FIG. 7) stages (both projections from above).

FIG. 8 demonstrates general view of the polymer cover.

FIG. 9 shows parts of the polymer enclosure.

FIGS. 10 and 11 shows clamping device for thin tubes: before clamping (FIG. 10) and after clamping (FIG. 11).

FIG. 12 shows clamping device with installed upper ends of thin tubes (projection from above).

FIG. 13 shows clamping device with installed upper ends of thin tubes (bottom projection).

### DETAILED DESCRIPTION OF A REPRESENTATIVE EMBODIMENT

Generally, fruit trees, palms and shrubs—large size plants—are able to grow only in particular planting zones if they are not protected. Thus, USA mainland has nine planting zones from 2 to 10. Plants from tropical humid climate (zone 10) are able to grow, for example, in South Florida and South California. Plants from subtropical and tropical dry climate (zone 9) are able to grow in Central and North Florida, South Texas, Central California. Plants of the zones 8 and 7 (Mediterranean and Oceanic climatic zones) grow in several populated states of the South Midwest. Current invention allows growing tropical trees and shrubs typical to zones 9 and 10 in zones 7 and 8, and those typical to zones 7 and 8 in zones 5 and 6 by simple and cost-effective manner without replanting.

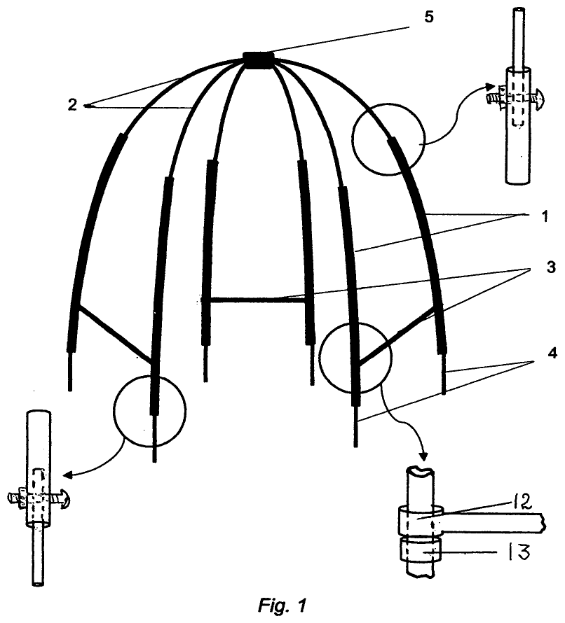

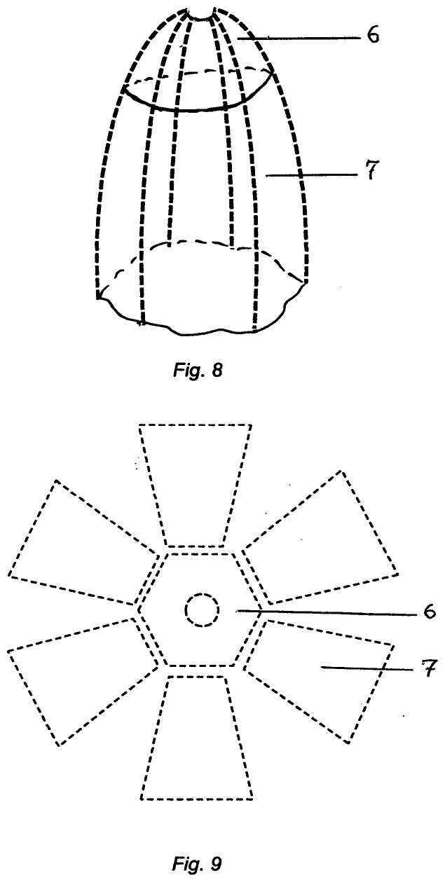

Expandable greenhouse of medium size (main embodiment) shown in FIG. 1. It consists of main parts: thick tubes (1), thin tubes (2), bearing bars (3), short tubes inserted in the soil (4) and clamping device (5). The frame is covered by clear polymer sheet (FIGS. 8 and 9). Enlarged version of thin tubes (2) inserted inside into thick tubes (1) are shown in separate picture (upper right). Lower end of thick tube (1) is put on the thinner tube (4). All of six tubes (4) are firmly inserted into the ground and serve to protect greenhouse from wind. This is illustrated on the lower-left in FIG. 1.

Thin tubes (2) are inserted inside thick tubes (1) but can be extended out at to required height. Thus, the height of the greenhouse can be extended. Position of thin tubes (2) fixed to thick tubes (1) by screws and bolts, rubber rings/stoppers or any other way.

All parts of construction must be reliably fixed to each other. Therefore, bearing bars (3) connect neighboring thick tubes (1). They attached to tubes through rings on the ends of bearing bars (12) and supported by rubber ring (13) as shown on separate lower right picture in FIG. 1. Attaching of bearing bars to thick tubes can also be done by connecting with screws, bolts or ropes or another manner.

Important part of construction is device fixing thin tubes in the top part of greenhouse (5). It serves to fix/assemble top part of thin tubes as well as disassemble when needed.

FIG. 2 shows greenhouse in initial—minimal stage (minimal area and height). The enclosed volume is smallest. Thin tubes (2) are not seen because completely covers inside thick tubes (1). The very top ends of thin tubes (2) firmly clamped inside a clamping device (5). The covered area is small because bearing bars (3) connected to second, fourth and sixth thick tubes.

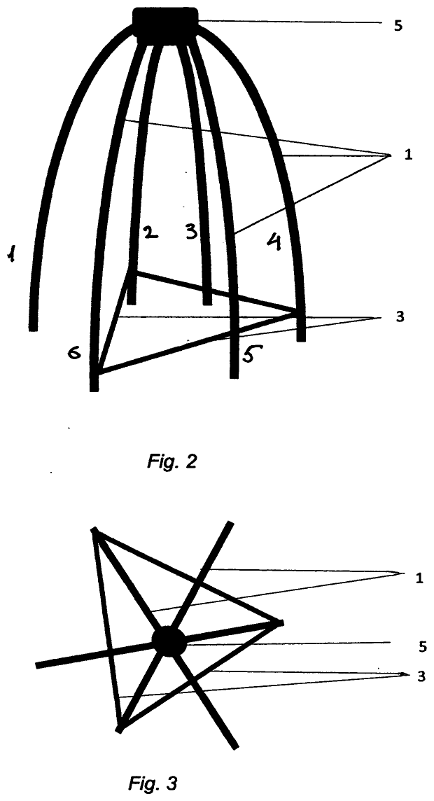

FIG. 3 demonstrates connections between bearing bars (3) and thick tubes (1) when greenhouse in minimal stage. Projection from above: three bearing bars fixed to three thick tubes.

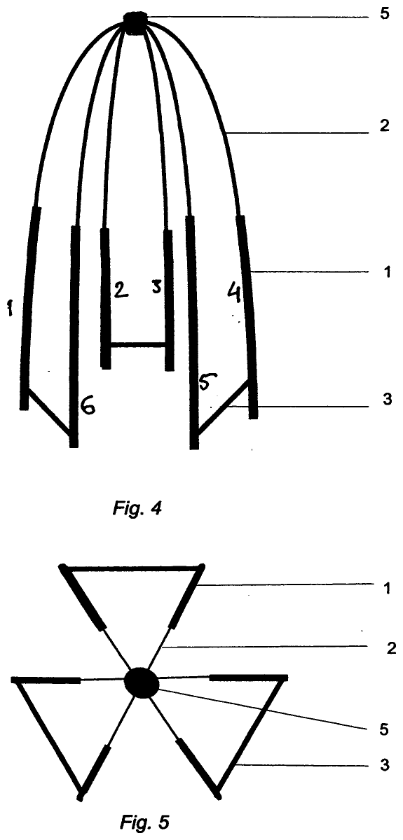

FIG. 4 shows greenhouse at maximal big stage: tubes (4) removed from the ground and firmly inserted in the ground at larger distance between them. Bearing bars (3) unplugged from thick tubes (1). Thick tubes (1) attached to the tubes (4). Bearing bars (3) attached to thick tubes (1) at different geometrical position as it shown on FIG. 5: first tube to sixth, second to third and forth to fifth. Thus, the area in unclosed volume is significantly increased. Clamping device (5) pushed up and pull thin tubes (2) out of the thick tubes (1). Thick and thin tubes fixed in maximal position by screws and bolts or any other manner. It is important to state that between minimal stage and maximal stage, there can be intermediate stages. Their height, area and volume can be easily adjusted by arranging the tubes (4), bearing bars (3) and the extended distance of thin tubes (2) extended out of thick tubes (1). This is important feature of construction because the size of greenhouse can be adjusted to the size of growing plant easily and without any additional parts.

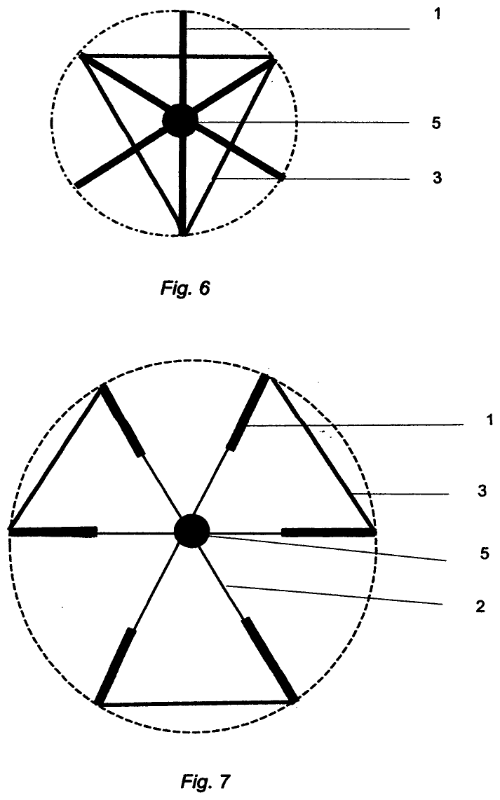

FIGS. 6 and 7 show attachment of bearing bars (3) to thick tubes (1). Geometrical calculations of two different positions of bearing bars shows that smallest covered area (S₁) is in 4 times smaller than biggest area (S₂) when bearing bars (3) re-arranged as it shown on FIG. 7. This explained by the fact that in FIG. 6, the radius (R) of the circle is the length of thick tube (1), which contains the thin tube (2) inside. On the re-arranging bearing bars (3) (FIG. 7)—the thin tube (2) is extended out practically to the length of thick tube (1). Therefore, the radius of circle in FIG. 7 doubled (2R).

S₁=πR² S₂=π(2R)² S₂/S₁=π(2R)²/πR²=4

The shape of greenhouse is close to hemisphere. The volume (V) of hemisphere is calculated using the formula: V=(⅔)πR³. The volume of greenhouse in smallest stage (V₁) when radius is equal to thick tube (1) (projection from above) is V₁=(⅔)πR³. After bearing bars (3) re-arranged as shown in FIG. 7 radius becomes sum of thick tube (1) and thin tube (2) or 2R. Thus, volume of greenhouse (V₂) when it has shape of hemisphere (i.e. height equal the length of radius 2R) will be

V₂=(⅔)π(2R)³. V₂/V₁=8

This means that the volume of greenhouse (shape of hemisphere) in the largest stage in 8 times larger than greenhouse (shape of hemisphere) in smallest stage.

It is important to state that the shape of greenhouse when bearing bars re-arranged (FIG. 7) is not typical hemisphere: height can be much larger than 2R: 3-7R. Therefore, difference of volumes can be much larger: 15-30 times.

Thus, all transformations of greenhouse (main embodiment) are done only by geometrical re-arrangement of constructive elements.

Important part of greenhouse is polymeric cover sheet. FIG. 8 demonstrates general view of the polymer cover sheet. According to main embodiment it consists of upper dome (6) and lower pieces (7). Material of sheet can be clear polyvinyl polymer, polyethylene or polycarbonate usually used for greenhouses. Other suitable clear polymers also can be used. Dome (6) is made from triangular pieces connected to each other like the top of an umbrella. The size of dome is the same as the size of greenhouse in a minimal stage. Increasing the size of greenhouse needs additional polymeric cover sheets. These parts (7) are demonstrated in FIG. 9. These sheets are attached to the framework of the greenhouse. Each one side of each sheet is attached to suitable side of the dome (6) and sides attached to each other. Thus, lower side of polymeric sheets can be turned into a tube according particular height. Combination of upper dome and six sheets (main embodiment) allows to cover greenhouse of any height. Alternatively (another embodiment) polymeric protective cover sheets can consists of several long sheets attached to clamping device (5) on top and attached along the sides to adjacent sheet by using glue, tape, Velcro patches, buttons or other manner. Also, this height of these unattached free sheets can be adjusted by rolling or unrolling these sheets into desired height to match the size of the expanding greenhouse.

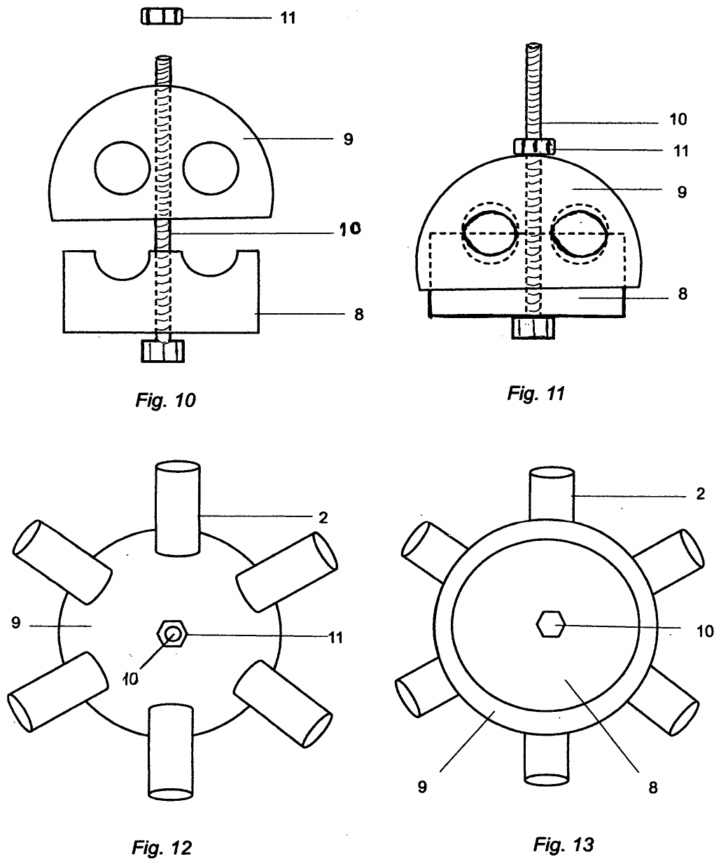

Important part of design of greenhouse is clamping device (5) shown in details in FIGS. 10-13.

The function of clamping device is to securely connect the ends of thin tubes (2). FIG. 10 demonstrates three main parts of clamping device before thin tubes are installed inside holes. It consists of a lower part (8), upper part (9) and relatively long screw (10). According main embodiment lower part (8) is cylindrical cap with open upper side and six semicircular impressions/half-holes (main embodiment). Upper part (9) is a cap with six (main embodiment) holes. Diameter of these holes are the same as diameter of thin tubes (2). During initial assembling of the greenhouse thin tubes (2) are inserted in the holes. Lower part (8) with long screw (10) attached to upper part (9) and long screw (10) tightens with bolt (11). Thus, the clamping device obtains shape/form as shown in FIG. 11: the lower part (8) inserted into the upper part (9) and the holes of upper part (9) align with half-holes of lower part (8) and clamp the ends of thin tubes (2) firmly.

FIG. 12 shows clamping device with already clamped thin tubes—projection from above. Six-sides compression bolt is in the center. FIG. 13 shows the same device but projection from bottom.

Invented expandable greenhouse can have different embodiments. Thus, the number of thick tubes with thin tubes inside can be different: 4, 8, 12 or other. The number bearing bars can be more than three: six, 8, 12 or more. Construction becoming stronger in the case with more thick and thin tubes, and bearing bars involved, but also more complex and more expensive.

The diameter of tubes and bars and thickness of walls can be different depending on climatic zone, winds or even snow.

The length of thick and thin tubes can be different and depends on quality of material, flexibility, diameter and thickness of the walls.

Design of expandable greenhouse is not restricted by only two types of tubes—thick and thin inserted one in another. It can be three or even four types of tubes inserted one in another. In these cases, height of greenhouse can be tripled or even quadrupled.

It can be useful to have special holes in plastic sheet for ventilation, heating, watering and adding fertilizers. Addition of thermometer is also very useful to regulate heating.

Lower side of clamping device (5) can be used to attach lamp for day light to compensate for the lack of light during dark winter time.

Theoretically it is possible to grow northern (like zones 5 and 6) trees like apples, plums, cherries in tropical climate (zones 9-11) if dark colored or reflective light plastic sheeting and/or cooling devices are used.

Current invention may have big economical effect because it allows cultivating relatively big trees or shrubs outside houses or winter gardens at another climatic zones by simple and economical manner without replanting.

In fact, simple and cost-effective growing of trees and shrubs can move 500-700 miles North from their normal habitat.

### EXAMPLES

### Example 1

Avocado Wurtz, Mango Kent and Indian tropical Curry Leaf Tree can grow without protection only in South and Central Florida (zone 10). They don't survive a few relatively cold winter nights even of North Florida. Protected by invented greenhouse these trees can survive and grow in the hardiness zones 9 and 8: North Florida, Georgia, South Carolina, Alabama, Mississippi, Louisiana, Arkansas, Texas and some other places. They reach an average height of 10-12 feet. Thus, these trees need expandable greenhouse of length of thick tubes 6-7 feet with 6-7 feet thin tubes inside each thick tube. Thus, in minimal position (young trees 1-3 years) the height of the green house will be 6-7 feet and cover small area of soil. During growth up to maturity the height of greenhouse will elongate according height of trees up to 12-14 feet. Covering area also will be significantly larger. It is important to use heating devices such as heating lamps, heat fan, candle, etc. during especially cold days or nights.

### Example 2

Fruit trees of Zone 8 (South North Carolina, Central South Carolina, Central Georgia, Central Louisiana, South Arkansas etc.) like Apricots, Pears, Peaches and in some places Oranges, Figs and Lemons can successfully grow in zones 7 and 6 (South Maryland, Virginia, Tennessee, Kentucky, Ohio, South Illinois etc.). Some of these trees create relatively big crown and have a height 14-16 feet when mature. The distance between thick tubes (area of soil inside greenhouse) needs to be 20-25 inch in first stage of growth and 40-45 inch in the second stage. Thick tubes and installed thin tubes must be 8-9 feet length in minimal position and 16-18 feet in maximal position.

The invention claimed is:

1. A greenhouse for protecting single tree or large plant from sprout to maturity installed once when plant is small and expanding in size to fit the size of growing plant comprising:
tubes of particular diameter hollow inside and tubes of smaller diameter installed inside first tubes;
rods or tubes sharpened from one side for driving into the ground on one end and installed inside hollow tubes on another end to strengthen construction;
bearing bars attached to the hollow tubes to strengthen construction and re-arranged when size of greenhouse increasing;
clamping device for attaching tubes of smaller diameter together;
clear polymer coating to protect inner space from harsh weather conditions;
pieces connecting parts of construction; screws, rubber or polymer rings, bolts.

2. A greenhouse for single tree or large plant according to claim 1, wherein number of thick tubes with thin tubes inside can be at least three in order to create structure with volume;

3. A greenhouse for single tree or large plant according to claim 1, wherein material of thick and thin tubes can be any flexible but rigid polymer or metal;

4. A greenhouse for single tree or large plant according to claim 1, wherein inner diameter of thick tubes fit the outer diameter of thin tubes in order to move thin tubes in and out;

5. A greenhouse for single tree or large plant according claim 1, wherein number of bearing bars can be from zero to several;

6. A greenhouse for single tree or large plant according to claim 1, wherein clamping device consists of two parts having inner volume and holes in upper part and half-holes in lower part and connected by screw with bolt in order to clamp upper ends of thin tube firmly;

7. A greenhouse for single tree or large plant according to claim 1, wherein clear polymer used for coating is polyvinyl, polyethylene, polycarbonate or other.

8. A greenhouse for single tree or large plant according to claim 7, clear polymer consists from upper—dome—part and sheets attached to dome;

9. A greenhouse for single tree or large plant according to claim 7, clear polymer consists from several long pieces of clear polymer fixed to clamping device.
